(19) United States
(12) Patent Application Publication
(10) Pub. No.: US 2018/0201718 A1
(43) Pub. Date: Jul. 19, 2018

(54) OPTICAL COMPOSITION FOR BLOCKING ELECTROMAGNETIC WAVES AND METHOD FOR MANUFACTURING OPTICAL LENS THEREFROM

(71) Applicants: Keun Sik KIM, Suncheon (KR); KS LABORATORIES CO., LTD., Suncheon (KR)

(72) Inventors: Keun Sik KIM, Suncheon (KR); Yeon Tak CHOI, Suncheon (KR)

(21) Appl. No.: 15/744,647

(22) PCT Filed: Jul. 12, 2016
(86) PCT No.: PCT/KR2016/007572

§ 371 Date: Jan. 12, 2018

(30) Foreign Application Priority Data
Jul. 13, 2015 (KR) 10-2015-0098847

(51) Int. Cl. C08G 18/72; C08G 18/73; C08G 18/75; C08G 18/76; C08G 18/38; C08G 18/24; C08K 5/00; C08J 7/06; G02C 7/10; E06B 9/24

(52) U.S. Cl. CPC C08G 18/724; C08G 18/73; C08G 18/755; C08G 18/758; C08G 18/7642; C08G 18/722; B29K 2075/00; C08G 18/242; C08K 5/0091; C08J 7/065; G02C 7/10; E06B 9/24; C08J 2375/04; C08G 18/3876

(57) ABSTRACT

The present invention relates to an optical composition for blocking near-infrared rays, comprising a mixture of a polyurethane-based thermosetting resin composition and a near-infrared absorbent, wherein the optical composition for blocking near-infrared rays comprises (1) at least one of polyisocyanate compounds in a liquid phase (I); (2) at least one of polyol or polythiol compounds in a liquid phase (II); and (3) a near-infrared absorbent having a high near-infrared absorbing ability of less than 5% in the range of 800-1000 nm, and to a method for manufacturing near-infrared blocking spectacle lens using the same. The spectacle lens obtained from the optical composition of the present invention can effectively prevent damage to the retina by effectively blocking near-infrared rays.

### TECHNICAL FIELD

The present invention relates to an optical composition using an optical resin composition capable of blocking electromagnetic waves, particularly UV light at a wavelength of 400 nm or less and/or near-infrared light at a wavelength of 800 nm to 1000 nm, and a method of preparing the same.

### BACKGROUND ART

Eyeglasses or sunglasses produced from the optical composition serve to correct eyesight and to protect eyes from harmful light such as UV light or infrared light.

UV light passing through the lens of the human eye denatures proteins, causing deterioration in eyesight. If the eyes are not protected from UV light, inflammation of the eyes can develop and the conjunctiva and cornea can be seriously damaged. Recently, as the intensity of UV light has increased with destruction of the ozone layer, the incidence of cataracts is increasing among younger generations in their 20s and 40s. This is thought to be mostly due to increase in frequency of exposure to UV light as outdoor activities such as mountain climbing, fishing, and jogging increase in popularity.

On the other hand, near-infrared light (NIR) refers to infrared light in a wavelength range closest to that of radiant energy of the sun (800 nm to 1,500 nm) and transfers heat waves only to an object without heating air. It is known that incoming rays of near-infrared light can be focused on the retina to an intensity that is 100,000 times higher than before entering the eye, causing damage to the retina.

A method of adding an infrared absorbent blocking transmission of infrared light or a UV absorbent blocking transmission of UV light is applied to sunglasses for blocking infrared light and UV light (for example, Japanese Patent Laid-Open Publication Nos. 2007-271744 and 2000-007871).

In particular, Japanese Patent No. 5166482 discloses an optical resin composition capable of blocking near-infrared light such that the resin composition has a transmittance of about 5% or less at a near-infrared wavelength of 800 nm to 1,000 nm. This document discloses a method of producing an optical lens, including: mixing a polycarbonate resin with a phthalocyanine pigment (A) blocking light in a wavelength range of 800 nm to 850 nm, a phthalocyanine pigment (B) blocking light in a wavelength range of 950 nm to 1,000 nm and a phthalocyanine pigment (C) blocking light in a wavelength range of 875 nm to 925 nm in a specific ratio; and melting and injection-molding the pigments together with the resin, and an eyeglass lens produced by the method.

According to Japanese Patent No. 5166482, any resin exhibiting excellent transparency can be used. For example, the resin may include diethylene glycol bis-allyl carbonate (CR-39), polymethylmethacrylate (PMMA), methyl methacrylate (MMA) and the like, preferably polycarbonate (PC). However, even though diethylene glycol bis-allyl carbonate (CR-39) disclosed in this document is a thermosetting resin and thus has different properties from polycarbonate (PC), that is, a thermoplastic resin, and is unable to be melted and injection-molded into a cavity in a mold, this document merely discloses diethylene glycol bis-allyl carbonate (CR-39) as being equivalent to other thermoplastic resins.

### DISCLOSURE

### Technical Problem

Although polycarbonate (PC), which is a thermoplastic resin, is a resin capable of being melted at a high temperature of 250° C. or more, there is a concern that phthalocyanine known as a near-infrared absorbent can be thermally decomposed upon injection molding together with such a thermoplastic resin. Further, there is a drawback such as difficulty in uniform distribution of the absorbent in a high-viscosity melted resin of a polycarbonate having a certain molecular weight. Therefore, to prepare an optical resin composition for blocking infrared light using phthalocyanine, the optical resin composition must be cured by mold polymerization, which is a mold injection method, at relatively low temperature allowing phthalocyanine not to be thermally decomposed. In addition, the absorbent is required to be mixed with a liquid monomer for polymers and thermally cured to be uniformly mixed with a monomer composition for thermosetting resins. Further, polycarbonate is unsuitable for use in eyeglass lenses due to birefringence properties thereof and is likely to be thermally deformed during processing.

### Technical Solution

In accordance with one aspect of the present invention, there is provided a preliminary composition for an optical composition for blocking electromagnetic waves, including: (1) at least one polyisocyanate compound; and (2) an electromagnetic wave absorbent having high near-infrared absorbency corresponding to a transmittance of less than 5% at a wavelength of 800 nm to 1,000 nm.

In accordance with another aspect of the present invention, there is provided an optical composition for blocking electromagnetic waves using a mixture of a thermosetting polyurethane resin composition and an electromagnetic wave absorbent, wherein the optical composition includes: (1) at least one polyisocyanate compound as a liquid (I); (2) at least one polythiol compound as a liquid (II); and (3) a near-infrared absorbent having high near-infrared absorbency corresponding to a transmittance of less than 5% at a wavelength of 800 nm to 1,000 nm, as one of the electromagnetic wave absorbents.

Particularly, in the preliminary composition, the electromagnetic wave absorbent may include a phthalocyanine pigment as a near-infrared absorbent. An optical composition obtained using the preliminary composition and a thermosetting polyurethane resin can effectively block electromagnetic waves.

### Advantageous Effects

According to the present invention, a sunglass (eyeglass) lens produced from the optical composition can effectively block near-infrared light having a wavelength of 800 nm to 1000 nm and UV light having a wavelength of 400 nm or less, thereby effectively protecting eyes from UV light and infrared light contained in sunlight.

### DESCRIPTION OF DRAWINGS

FIG. 1 is a graph depicting typical UV-Vis-NIR absorption spectra of near-infrared blocking lenses as obtained by evaluating near-infrared absorbency of the lenses, in which a curve EXP-1 is a spectrum obtained when only a UV absorbent is used; a curve EXP-2 is a spectrum obtained when the UV absorbent and 500 ppm of a near-infrared absorbent are used; a curve EXP-3 is a spectrum obtained when the UV absorbent and 800 ppm of the near-infrared absorbent are used; and a curve EXP-4 is a spectrum obtained when the UV absorbent and 1000 ppm of the near-infrared absorbent are used.

FIGS. 2 to 8 are graphs depicting UV-Vis-NIR absorption spectra of lenses prepared in Examples 1 to 7, respectively, as obtained by evaluating near-infrared absorbency of the lenses.

FIGS. 9 and 10 are graphs depicting UV-Vis-NIR absorption spectra of lenses prepared in Examples 8 and 9, respectively, as obtained by evaluating near-infrared absorbency of the lenses.

FIG. 11 is a graph depicting UV-Vis-NIR absorption spectra of a lens prepared in Example 10, as obtained by evaluating near-infrared absorbency of the lens.

### BEST MODE

Hereinafter, embodiments of the present invention will be described in detail with reference to the accompanying drawings.

FIG. 1 is a graph depicting typical UV-Vis-NIR absorption spectrum analysis results of near-infrared blocking lenses, wherein a Y-axis represents light transmittance (T %), and an X-axis represents wavelength (nm). In the graph of FIG. 1, a blue curve EXP-1 at the uppermost position shows that UV light having a wavelength of 400 nm or less is blocked by adding the UV absorbent added to the optical composition.

In addition, the other three curves EXP-2, EXP-3 and EXP-4 of FIG. 1 show that only a portion of visible light having a wavelength of 400 nm to 800 nm is blocked using both the UV absorbent and the near-infrared absorbent, and that lenses have a visible light transmittance of 10% to 20%. If a lens has a visible light transmittance of 0%, since light is not visible when a person wears the lens, a lens having higher transmittance is better. However, since a lens has an adverse effect of blocking visible light if a large amount of the near-infrared absorbent is added to the optical composition, it is necessary to add a suitable amount of the near-infrared absorbent.

In particular, the three curves of FIG. 1 are plotted according to concentration of the near-infrared absorbent, and the two curves EXP-3 and EXP-4 at lower positions show that the lenses have a transmittance of almost 0% in a near-infrared range (800 nm to 1000 nm) and block near-infrared light, and that the near-infrared light absorbent is present in an appropriate concentration in the optical composition according to the present invention.

Generally, a polyurethane eyeglass lens is produced through a process in which a polyisocyanate as a liquid (I) and a polyol or polythiol as a liquid (II) are mixed, followed by degassing the mixture, thereby obtaining a uniform optical composition, which, in turn, is cured in a desired glass mold and then released from the mold. Since an isocyanate functional group (—NCO) can easily polymerize with a polyol functional group (—OH) or polythiol functional group (—SH) when mixed, the liquid (I) and the liquid (II) need to be separately prepared and stored. In addition, in order to obtain a lens-shaped resin, the two liquids need to be injected into the mold immediately after mixing, followed by polymerization through a curing process. Therefore, the liquid (I) and the liquid (II) must be separately prepared and stored.

Further, a polyurethane-based eyeglass lens for blocking near-infrared light further includes a near-infrared absorbent including at least one pigment, in addition to the polyisocyanate as the liquid (I) and the polyol or polythiol as the liquid (II). Since the near-infrared absorbent is a solid, a uniform absorbent solution must be prepared in advance by uniformly mixing the near-infrared absorbent with the polyisocyanate used in the liquid (I).

According to the present invention, there is provided a preliminary composition for an optical composition, which is mainly composed of a polyisocyanate and an electromagnetic wave absorbent. In accordance with one aspect of the present invention, a preliminary composition for an optical composition for blocking electromagnetic waves includes: (1) at least one polyisocyanate compound; and (2) an electromagnetic wave absorbent having high near-infrared absorbency corresponding to a transmittance of less than 5% at a wavelength of 800 nm to 1,000 nm.

The electromagnetic wave absorbent includes a near-infrared absorbent in an amount of 0.01% by weight (wt %) to 0.5 wt %, preferably 0.02 wt % to 0.1 wt %, more preferably 0.03 wt % to 0.08 wt %, based on the total weight of the preliminary composition for the optical composition. If the amount of the near-infrared absorbent is below this range, the preliminary composition can have poor near-infrared absorbency, whereas, if the amount of the near-infrared absorbent is above this range, economic efficiency can be deteriorated.

Since UV light has a shorter wavelength than visible light (400 nm to 800 nm) and only such short wavelengths need to be blocked, a UV absorbent known in the art is mixed with the optical composition. On the other hand, since infrared light has a longer wavelength than visible light, if an infrared absorbent unconditionally blocks infrared light, the infrared absorbent also blocks visible light unlike the UV absorbent, and thus a special absorbent must be used. In particular, the amount of the near-infrared absorbent must be finely adjusted such that the near-infrared absorbent blocks only a portion of visible light and provides a transmittance of 20% or more.

In the present invention, (3) at least one polyol or polythiol compound as a liquid (II) may be added to the preliminary composition for the optical composition, including: (1) the at least one polyisocyanate compound; and (2) the electromagnetic wave absorbent having near-infrared absorbency, thereby preparing a final optical composition for blocking electromagnetic waves. Alternatively, a final optical composition for blocking electromagnetic waves according to the present invention may be prepared by sequentially mixing (1) the polyisocyanate compound; (2) the polyol or polythiol compound; and (3) the electromagnetic wave absorbent, as described below.

In accordance with another aspect of the present invention, there is provided an optical composition for blocking electromagnetic waves using a mixture of a thermosetting polyurethane resin composition and an electromagnetic wave absorbent,

the optical composition including:

(1) at least one polyisocyanate compound as a liquid (I);

(2) at least one polyol or polythiol compound as a liquid (II); and

(3) a near-infrared absorbent having high near-infrared absorbency corresponding to a transmittance of less than 5% at a wavelength of 800 nm to 1000 nm, as one of the electromagnetic wave absorbents.

Preferably, the polyisocyanate compound includes at least one selected from the group consisting of xylylene diisocyanate (XDI), 2,5(6)-bis(isocyanatomethyl)bicyclo[2,2,1]heptane (NBDI), 1,6-hexamethylene diisocyanate (HDI), isophorone diisocyanate (IPDI), dicyclohexylmethane diisocyanate (H12MDI), and a biuret of aliphatic isocyanate.

Preferably, the polythiol compound includes at least one selected from the group consisting of 2,3-bis(2-mercaptoethylthio)propane-1-thiol (GST), pentaerythritol tetrakis(mercaptopropionate) (PEMP), 1,3-bis(2-mercaptoethylthio)propane-2-thiol (MET), (3,6,10,13-tetrathiapentadecane-1,8,15-trithiol) (SET), 2-(2-mercaptoethylthio) propane-1,3-dithiol (GMT), and 4,8-dimercaptomethyl-1,11-dimercapto-3, 6,9-trithiaundecane (DMDDU).

Preferably, the near-infrared absorbent is a mixture of a plurality of phthalocyanine pigments having different structures. More preferably, the plurality of phthalocyanine pigments have a transmittance of less than 10% as minimum values of spectral transmittance curves in (i) a wavelength range of 800 nm to 850 nm, (ii) a wavelength range of 875 nm to 925 nm, and (iii) a wavelength range of 950 nm to 1000 nm, respectively.

In one embodiment, the optical composition may include at least one UV absorbent capable of absorbing UV light having a wavelength of 400 nm or less, selected from the group consisting of:

2-(2′-hydroxy-5-methylphenyl)-2H-benzotriazole; 2-(2′-hydroxy-3′,5′-di-t-butylphenyl)-5-chloro-2H-benzotriazole; 2-(2′-hydroxy-3′-t-butyl-5′-methylphenyl)-5-chloro-2H-benzotriazole; 2-(2′-hydroxy-3′,5′-di-t-amylphenyl)-2H-benzotriazole; 2-(2′-hydroxy-3′,5′-di-t-butylphenyl)-2H-benzotriazole; 2-(2′-hydroxy-5′-t-butylphenyl)-2H-benzotriazole; 2-(2′-hydroxy-5′-t-octylphenyl)-2H-benzotriazole; 2,4-dihydroxybenzophenone; 2-hydroxy-4-methoxybenzophenone; 2-hydroxy-4-octyloxybenzophenone; 4-dodecyloxy-2-hydroxybenzophenone; 4-benzyloxy-2-hydroxybenzophenone(; 2,2′,4,4′-tetrahydroxybenzophenone; and 2,2′-dihydroxy-4,4′-dimethoxybenzophenone.

In one embodiment, the optical composition for blocking electromagnetic waves according to the present invention may be used as a windowpane for sliding windows, double or single hung windows or casement windows which require electromagnetic wave blocking.

In addition, the optical lens produced from the optical composition for blocking electromagnetic waves according to the present invention may further have a polarizing function, a dimming function, or a combination thereof.

In accordance with a further aspect of the present invention, there is provided a method of producing an optical lens for blocking electromagnetic waves by molding a mixture of a thermosetting polyurethane resin composition and an electromagnetic wave absorbent through mold polymerization, the method including:

(1) obtaining a liquid (I) of an optical composition including at least one polyisocyanate compound;

(2) obtaining a liquid (II) of the optical composition including at least one polyol or polythiol compound;

(3) obtaining a uniform electromagnetic wave absorbent solution by mixing the polyisocyanate compound used in the liquid (I) with a near-infrared absorbent, a UV absorbent, or both thereof, wherein the near-infrared absorbent has high near-infrared absorbency corresponding to a transmittance of less than 5% at a wavelength of 800 nm to 1000 nm, and the UV absorbent has absorbency of UV light with a wavelength of 400 nm or less; and

(4) mold-polymerizing the optical composition prepared by mixing the liquid (I), the liquid (II), and the electromagnetic wave absorbent solution.

Alternatively, a desired optical lens for blocking electromagnetic waves may be produced by mold-polymerizing a mixture of a polyisocyanate compound and a polyol or polythiol compound to obtain an optical lens, followed by coating the obtained optical lens with a near-infrared absorbent coating solution.

In accordance with yet another aspect of the present invention, there is provided a method of producing an optical lens for blocking electromagnetic waves,

the method including:

(1) obtaining a liquid (I) of an optical composition including at least one polyisocyanate compound and a liquid (II) of the optical composition including at least one polyol or polythiol compound;

(2) preparing an optical lens by mold-polymerizing a mixture of the liquid (I) and the liquid (II);

(3) obtaining a near-infrared absorbent coating solution by dissolving a mixture of a plurality of phthalocyanine pigments in an emulsion and a solution, wherein the phthalocyanine pigments has different structures and high near-infrared absorbency corresponding to a transmittance of less than 5% at a wavelength of 800 nm to 1000 nm;

(4) forming an electromagnetic wave blocking layer by coating at least one surface of the optical lens obtained in step (2) with the near-infrared absorbent coating solution obtained in step (3); and

(5) drying or curing the electromagnetic wave blocking layer formed on at least one surface of the optical lens.

In step (4), coating is preferably performed by at least one of spin coating, dip coating, spray coating, and roll coating. In addition, the method may further include subjecting the optical lens having the electromagnetic wave shielding layer formed thereon, to at least one of hard coating, multi-coating, UV coating, photochromic coating, water film coating, and super water-repellent coating.

Although the emulsion used to obtain the near-infrared absorbent coating solution may include any typical emulsion used in polyurethane production, the emulsion is preferably SANPRENE®LQ 3510 (Sanyo Chemical Industries). In addition to the emulsion, a variety of fluorinated surfactants/surface modifiers may be further used. Particularly, FLUORAD®FC-430 (fluoroaliphatic polymeric ester) commercially available from 3M Company is preferred.

In the present invention, the polyisocyanate compound used in the liquid (I) may include aliphatic polyisocyanates, alicyclic polyisocyanates, and aromatic polyisocyanates. Examples thereof are as follows:

i) aliphatic polyisocyanates: ethylene diisocyanate, trimethylene diisocyanate, tetramethylene diisocyanate, hexamethylene diisocyanate, octamethylene diisocyanate, nonamethylene diisocyanate, 2,2′-dimethylpentane diisocyanate, 2,2,4-trimethylhexane diisocyanate, decamethylene diisocyanate, butylene diisocyanate, 1,3-butadiene-1,4-diisocyanate, 2,4,4-trimethylhexamethylene diisocyanate, 1,6,11-undecane triisocyanate, 1,3,6-hexamethylene triisocyanate, 1,8-diisocyanate-4-isocyanate methyloctane, 2,5,7-trimethyl-1,8-diisocyanate-5-isocyanate methyloctane, bis(isocyanate ethyl)carbonate, bis(isocyanate ethyl)ether, 1,4-butylene glycol dipropyl ether-W, W′-diisocyanate, ridine diisocyanate methylester, ridine triisocyanate, 2-isocyanatoethyl-2,6-diisocyanate hexanoate, 2-isocyanatopropyl-2,6-diisocyanate hexanoate, xylylene diisocyanate, bis(isocyanatoethyl)benzene, bis(isocyanatopropyl)benzene, α,α,α′,α′-tetramethylxylylene diisocyanate, bis(isocyanatobutyl)benzene, bis(isocyanatomethyl)naphthalene, bis(isocyanatomethyl)diphenylether, bis(isocyanatoethyl)phthalate, mesitylene triisocyanate, 2,6-di(isocyanatomethyl)furan, and the like,

ii) alicyclic polyisocyanates: isophorone diisocyanate, bis(isocyanatomethyl)cyclohexane, dicyclohexylmethane diisocyanate, cyclohexane diisocyanate, methylcyclohexane diisocyanate, dicyclohexyl dimethylmethane diisocyanate, 2,2′-dimethyldicyclohexylmethane diisocyanate, bis(4-isocyanato-n-butylidene)pentaerythritol, dimeric acid diisocyanate, 2-isocyanatemethyl-3-(3-isocyanatopropyl)-5-isocyanatemethyl-bicyclo-[2,2,1]-heptane, 2-isocyanatemethyl-3-(3-isocyanatopropyl)-6-isocyanatemethyl-bicyclo-[2,2,1]-heptane, 2-isocyanatemethyl-2-(3-isocyanatopropyl)-5-isocyanatemethyl-bicyclo-[2,2,1]-heptane, 2-isocyanatemethyl-3-(3-isocyanatopropyl)-6-isocyanatemethyl-bicyclo-[2,2, 1]-heptane, 2-isocyanatemethyl-3-(3-isocyanatopropyl)-5-(2-isocyanatemethyl)-bicyclo-[2,2,1]-heptane, 2-isocyanatemethyl-3-(3-isocyanatopropyl)-6-(2-isocyanatemethyl-bicyclo-[2,2,1]-heptane, 2-isocyanatemethyl-3-(3-isocyanatopropyl)-5-(2-isocyanatemethyl-bicyclo-[2,2,1]-heptane, 2-isocyanatemethyl-3-(3-isocyanatopropyl)-6-(2-isocyanatemethyl-bicyclo-[2,2,1]-heptane, and the like.

iii) aromatic polyisocyanates: phenylene diisocyanate, toluene diisocyanate, ethylphenylene diisocyanate, isopropylphenylene diisocyanate, dimethylphenylene diisocyanate, diethylphenylene diisocyanate, diisopropylphenylene diisocyanate, trimethylbenzene triisocyanate, benzene triisocyanate, naphthalene diisocyanate, methylnaphthalene diisocyanate, biphenyl diisocyanate, toluidine diisocyanate, 4,4′-diphenylmethane diisocyanate, 3,3′-dimethyldiphenylmethane-4,4′-diisocyanate, bibenzyl-4,4′-diisocyanate, bis(isocyanatophenyl)ethylene, 3,3′-dimethoxybiphenyl-4,4′-diisocyanate, triphenylmethane triisocyanate, polymeric MDI, naphthalene triisocyanate, diphenylmethane-2,4,4′-triisocyanate, 3-methyldiphenylmethane-4,6,4′-triisocyanate, 4-methyldiphenylmethane-3,5,2′,4′,6′-pentaisocyanate, phenylisocyanatomethyl isocyanate, phenylisocyanatoethyl phenylisocyanate, tetrahydronaphthalene diisocyanate, hexahydrobenzene diisocyanate, hexahydrodiphenylmethane-4,4′-diisocyanate, diphenylether diisocyanate, ethyleneglycol-diphenylether diisocyanate, 1,3-propyleneglycol-diphenylether diisocyanate, benzophenone diisocyanate, diethyleneglycol-diphenylether diisocyanate, dibenzofuran diisocyanate, carbazole diisocyanate, ethylcarbazole diisocyanate, dichlorocarbazole diisocyanate, and the like.

Particularly, meta-xylylene diisocyanate (XD I), 2,5(6)-bis(isocyanatomethyl)bicyclo[2,2,1]heptane (NBDI), 1,6-hexamethylene diisocyanate (HDI), isophorone diisocyanate (IPDI), or dicyclohexylmethane diisocyanate (H12MDI) is preferred. In addition, a biuret of isocyanates and a trimer of isocyanates (for example, polyisocyanurate) may also be used. Here, an aliphatic biuret of HDI may be an isocyanate compound represented by Formula (1):

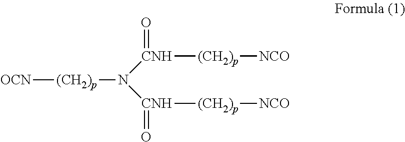

The biuret-type isocyanate compound represented by Formula (1) may be easily prepared from a raw material such as 1,2-ethylene diisocyanate, 1,3-propylene diisocyanate, 1,4-butylene diisocyanate, 1,6-hexamethylene diisocyanate, 1,7-heptamethylene diisocyanate, 1,8-ocatmethylene diisocyanate, 1,9-nonamethylene diisocyanate, and 1,10-decamethylene diisocyanate. In addition, the prepared compound may be purified before use or may include a raw material monomer itself, and the biuret-type isocyanate compound may include any suitable commercially available product such as Desmodur N100 (Bayer Co., Ltd.) or Tolonate HDB LV (Perstop Co. Ltd.). Further, a trimer-type isocyanate compound may also be easily prepared from the raw materials as the biuret set forth above, or may use any suitable commercially available product such as Tolonate HDT LV (Vencorex Chemicals).

In the present invention, the polyol compound used in the liquid (II) may include any typical polyol used in polyurethane production. Particularly, the polythiol compound may include one or two selected from the group consisting of:

1,2-bis(2-mercaptoethylthio)-3-mercaptopropane, trimethylolpropane tris(mercaptopropionate), pentaerythritol tetrakis(mercaptopropionate), 2,3-bis(2-mercaptoethylthio)propane-1-thiol, 2-(2-mercaptoethylthio)-3-[2-(3-mercapto-2-(2-mercaptoethylthio)-propylthio)ethylthio-propane-1-thiol, 2-(2-mercaptoethylthio)-3-{2-mercapto-3-[3-mercapto-2-(2-mercaptoethylthio)-propylthio]propylthio}-propane-1-thiol, trimethylolpropane tris(mercaptopropionate), trimethylolethane tris(mercaptopropionate), glycerol tris(mercaptopropionate), trimethylolchloro tris(mercaptopropionate), trimethylolpropane tris(mercaptoacetate), trimethylolethane tris(mercaptoacetate), pentaerythritol tetrakis(mercaptoacetate), [1,4]dithian-2-yl-methanethiol, 2-(2-mercapto-ethylsulfanyl)-propane-1,3-dithiol, 2-([1,4]dithian-2-ylmethylsulfanyl)-ethanethiol, 3-(3-mercapto-propionylsulfanyl)-propionic acid 2-hydroxylmethyl-3-(3-mercapto-propionyloxy)-2-(3-mercapto-propionyloxymethyl)-propylester, 3-(3-mercapto-propionylsulfanyl)-propionic acid 3-(3-mercapto-propionyloxy)-2,2-bis-(3-mercapto-propionyloxymethyl)-propylester, (5-mercaptomethyl-[1,4]dithian-2-yl)-methanethiol, (3,6,10,13-tetrathiapentadecane-1,8,15-trithiol)(SET), 2-(2-mercaptoethylthio)propane-1,3-dithiol (GMT), and 4,8-dimercaptomethyl-1,11-dimercapto-3,6,9-trithiaundecane (DMDDU).

Particularly, 2,3-bis(2-mercaptoethylthio)-propane-1-thiol (GST), 1,3-bis(2-mercaptoethylthio)propane-2-thiol (MET), (3,6,10,13-tetrathiapentadecane-1,8,15-trithiol) (SET), or pentaerythritol tetrakis(mercaptopropionate) (PEMP) is preferred. More preferably, the polythiol compound according to the present invention is a mixture of 2,3-bis(2-mercaptoethylthio)-propane-1-thiol (GST) and pentaerythritol tetrakis(mercaptopropionate) (PEMP).

2,3-bis(2-mercaptoethylthio)-propane-1-thiol (GST), 1,3-bis(2-mercaptoethylthio)propane-2-thiol (MET), (3,6,10,13-tetrathiapentadecane-1,8,15-trithiol) (SET), pentaerythritol tetrakis(mercaptopropionate) (PEMP), 2-(2-mercaptoethylthio)propane-1,3-dithiol (GMT), and 4, 8-dimercaptomethyl-1, 11-dimercapto-3,6, 9-trithiaundecane (DMDDU), which are preferred as the polythiol compound according to the present invention, are represented by the following formulae, respectively:

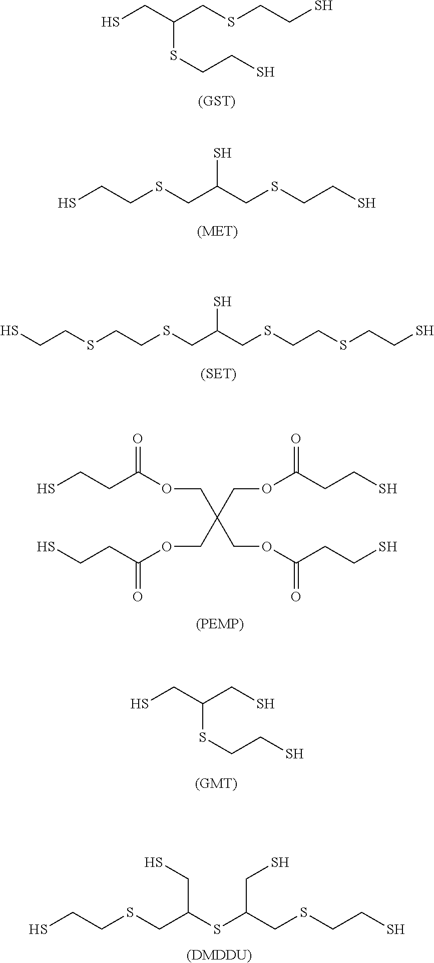

According to the present invention, a mole ratio (NCO/SH) of a functional group (—NCO) of the polyisocyanate used as the liquid (I) to a functional group (—SH) of the polythiol used as the liquid (II) may range from 0.5 to 1.5. In order to further improve properties of the optical lens, the mole ratio is preferably in the range of 0.9 to 1.1, more preferably 1.0.

When the biuret (derived from HDI), HDI, and IPDI are used as the polyisocyanate, a weight ratio therebetween (biuret:HDI:IPDI) is preferably of 30 to 40:20 to 30:30 to 40. When the polythiol includes only GST, a resin having a high index of refraction (nD) of 1.59 to 1.60 can be obtained, and when the polythiol includes only PEMP, it is possible to obtain a resin which has an index of refraction (nD) of 1.55 to 1.56 and is useful as a medium refractivity lens. Thus, the polythiol is not particularly limited. However, in order to produce a high refractivity lens, which has a high Abbe number of 39 to 48 and an index of refraction (nD) of 1.59 to 1.60 while exhibiting heat resistance and preventing whitening, yellowing and the like, the polythiol preferably includes GST and PEMP appropriately mixed therein. PEMP is preferably present in an amount of 10 wt % to 20 wt %, more preferably 14 wt % to 18 wt % in the polythiol. If the amount of PEMP is outside of this range, the optical composition tends to have slightly reduced impact resistance, and if the amount of PEMP is greater than 20 wt %, the optical composition also has reduced index of refraction. Therefore, it is desirable that the amount of PEMP be suitably adjusted.

A near-infrared absorbent solution capable of being used for the lens according to the present invention is not particularly limited so long as the near-infrared absorbent solution is a solution of a pigment having maximum absorption in a near-infrared range (wavelength of 800 nm to 1,200 nm). However, a phthalocyanine pigment is well known as a near-infrared absorbent, and a process, in which a threshold of absorption wavelength thereof changes due to a different molecular structure, is also well known. Thus, according to the present invention, various phthalocyanine pigments having different thresholds of absorption wavelength may be used, as needed. To increase absorption in the near-infrared range, a solution in which at least two near-infrared absorbents are mixed may be used. Examples of a commercially available phthalocyanine pigment may include Excolor IR-series, TXEX series (Nippon Shokubai Co., Ltd.), MIR-369, MIR-389 (Mitsui Co., Ltd.), PANAX (Ukseung Chemical Co., Ltd.), and the like.

The kind and amount of phthalocyanine pigment may be determined from change in a spectral transmittance curve by preliminary examples in a state that a transmittance of 10% to 20% in a visible light range is secured. For example, a spectral transmittance curve of a transparent resin may be analyzed, wherein the transparent resin is obtained by adding a plurality of phthalocyanine pigments having different structures in suitable amounts within a certain range based on a certain amount of a composition of monomers for polyurethane resins. If the amount of the phthalocyanine pigment is low, the optical polymerizable composition has insufficient absorption capabilities in the near-infrared range, and if the amount of the phthalocyanine pigment is high, the optical polymerizable composition has insufficient transparency in the visible light range, thereby leading to deterioration in properties of the eyeglass lens.

According to the present invention, a plurality of phthalocyanine pigments is selected such that the optical polymerizable composition has high near-infrared absorption capabilities corresponding to a transmittance of less than 5% at a wavelength of 800 nm to 1,000 nm. Next, certain amounts of the pigments are added in a certain weight ratio, followed by repeatedly analyzing a spectral transmittance curve of the obtained transparent polyurethane resin, thereby determining optimum combination and amounts of the phthalocyanine pigments.

According to the present invention, through such preliminary examples, the following commercially available phthalocyanine compounds (Ukseung Chemical Co., Ltd.) may be used:

(i) PANAX FND-83 as a phthalocyanine pigment (I) having a transmittance of less than 10% as a minimum value of a spectral transmittance curve in a wavelength range of 800 nm to 850 nm;

(ii) PANAX FND-88 as a phthalocyanine pigment (II) having a transmittance of less than 10% as a minimum value of a spectral transmittance curve in a wavelength range of 875 nm to 925 nm; and

(iii) PANAX FND-96 as a phthalocyanine pigment (III) having a transmittance of less than 10% as a minimum value of a spectral transmittance curve in a wavelength range of 950 nm to 1000 nm.

According to the present invention, in a preliminary example, amounts of a plurality of phthalocyanine pigments were determined by adding the phthalocyanine pigments or by increasing the amounts thereof in the range of 0.01 g to 100 g based on 100 kg of a poly(thio)urethane composition. As a result, the pigments may be present in amounts of about 10 g to 80 g based on 100 kg of the poly(thio)urethane composition.

According to the present invention, the UV absorbent, which is used to improve light resistance of a plastic eyeglass lens and to block UV light, may be any UV absorbent known in the art without limitation so long as the UV absorbent is able to be used in a resin composition for eyeglass lenses. For example, the UV absorbent may include ethyl-2-cyano-3,3-diphenylacrylate, 2-(2′-hydroxy-5-methylphenyl)-2H-benzotriazole, 2-(2′-hydroxy-3′,5′-di-t-butylphenyl)-5-chloro-2H-benzotriazole, 2-(2′-hydroxy-3′-t-butyl-5′-methylphenyl)-5-chloro-2H-benzotriazole, 2-(2′-hydroxy-3′,5′-di-t-amylphenyl)-2H-benzotriazole, 2-(2′-hydroxy-3′,5′-di-t-butylphenyl)-2H-benzotriazole, 2-(2′-hydroxy-5′-t-butylphenyl)-2H-benzotriazole, 2-(2′-hydroxy-5′-t-octylphenyl)-2H-benzotriazole, 2,4-dihydroxybenzophenone, 2-hydroxy-4-methoxybenzophenone, 2-hydroxy-4-octyloxybenzophenone, 4-dodecyloxy-2-hydroxybenzophenone, 4-benzyloxy-2-hydroxybenzophenone, 2,2′,4,4′-tetrahydroxybenzophenone, 2,2′-dihydroxy-4,4′-dimethoxybenzophenone, and the like. These UV absorbents may be used alone or in combination thereof. Preferably, the UV absorbent includes 2-(2′-hydroxy-5-methylphenyl)-2H-benzotriazole, 2-hydroxy-4-methoxybenzophenone, ethyl-2-cyano-3,3-diphenylacrylate, 2-(2′-hydroxy-5′-t-octyl phenyl)-2H-benzotriazole, 2,2′-dihydroxy-4,4′-dimethoxybenzophenone, 2-(2′-hydroxy-3′,5′-di-t-amylphenyl)-2H-benzotriazole, 2-(2′-hydroxy-3,5′-di-t-butylphenyl)-5-chloro-2H-benzotriazole, 2-(2′-hydroxy-3′-t-butyl-5′-methylphenyl)-5-chloro-2H-benzotriazole, and 2,2-dihydroxy-4,4′-dimethoxybenzophenone, which have good ultraviolet absorption capabilities at a wavelength of 400 nm or less and good solubility in the composition according to the present invention.

According to the present invention, in order to effectively block UV light and to improve photostability, the UV absorbent is present in an amount of 0.001 wt % to 10 wt % (10 ppm to 100,000 ppm), preferably 0.1 wt % to 5 wt % (1,000 ppm to 50,000 ppm), more preferably 0.3 wt % to 2 wt % (3,000 ppm to 20,000 ppm) based on 100 kg of the poly(thio)urethane composition. If the amount of the UV absorbent is less than this range, it is difficult to effectively block harmful UV light, and if the amount of the UV absorbent is greater than this range, it is difficult to dissolve the UV absorbent in the optical lens composition and a cured optical lens can suffer from dot patterns generated on a surface thereof or exhibit deteriorated transparency.

According to the present invention, in order to uniformly prepare an absorbent including the near-infrared absorbent, a uniform absorbent solution is prepared by uniformly mixing the near-infrared absorbent with the polyisocyanate used as the liquid (I). A resin monomer used for a solution of the near-infrared absorbent is not particularly limited so long as the near-infrared absorbent can be uniformly dissolved or dispersed in the resin monomer. The resin monomer used for the solution of the near-infrared absorbent may include polyester, acrylic, polyamide, polyurethane, polyolefin, and polycarbonate resins. However, since the polyisocyanate is used as the liquid (I) in the polyurethane optical composition according to the present invention, a portion of the polyisocyanate may be used as is.

In order to achieve required viscosity of the composition and achieve necessary optical properties thereof, such as transparency, index of refraction, specific gravity, impact resistance and heat resistance, which are required for a lens obtained from the composition, the composition may include various additives. In addition, various materials such as photostabilizers, antioxidants, and bluing agents correcting initial color of a monomer may be added, in addition to the UV absorbent for blocking UV light.

In addition, in order to adjust reaction rate to a desired level, a reaction catalyst may be appropriately added to the composition. The catalyst may include, for example, as a urethanization catalyst, tin compounds such as dibutyltin dilaurate, dibutyltin dichloride, dimethyltin dichloride, tetramethyldiacetoxydistannoxane, tetraethyldiacetoxydistannoxane, tetrapropyldiacetoxydistannoxane, and tetrabutyldiacetoxydistannoxane, and amine compounds such as tertiary amines. These catalysts may be used alone or in combination thereof. The catalyst may be present in an amount of 0.001 wt % to 1 wt % based on the total weight of a monomer of the composition. Within this range, the composition can have good polymerizability and pot life, and the obtained resin can have good optical properties such as transparency, and light resistance.

In addition, the resin composition for optical lenses according to the present invention may further include a bluing agent correcting initial color of the lens. Examples of the bluing agent may include an organic dye, an organic pigment, and an inorganic pigment. In one embodiment, the bluing agent including an organic dye and the like is present in an amount of 0.1 ppm to 50,000 ppm, preferably 0.5 ppm to 10,000 ppm in the resin composition for optical lenses to correct an undesirable initial color of the lens, which is caused by addition of the UV absorbent and use of the optical resin and the monomer.

According to the present invention, the resin composition for optical lenses may further include a release agent and a polymerization initiator, which are generally used. The release agent may be selected from fluorine-based nonionic surfactants, silicone-based nonionic surfactants, and alkyl quaternary ammonium salts. These release agents may be used alone or in combination thereof. Preferably, the release agent includes a phosphoric acid ester. In addition, the polymerization initiator may include amine compounds, tin compounds, and the like. These polymerization initiators may be used alone or in combination thereof.

Whether the polyurethane lens produced according to the present invention has suitable properties as a near-infrared blocking eyeglass lens needs to be evaluated. As properties of the lens, (1) index of refraction (nD) and Abbe number (υd), (2) impact resistance, (3) heat resistance (Tg), and (4) visible and near-infrared transmittance were evaluated by the following methods.

(1) Index of refraction (nD) and Abbe number (υd): Index of refraction and Abbe number were measured using an Abbe refractometer (model: 1T, ATAGO Co., Ltd.).

(2) Impact resistance: Impact resistance was measured in accordance with FDA test standards as follows. Steel balls were dropped from a height of 127 cm onto a specimen, which was a flat lens having a diameter of 80 mm and a thickness of 1.2 mm, at room temperature (20° C.) in order from light weight to heavy weight, and potential energy corresponding to a weight causing the specimen to be broken was measured, thereby evaluating impact resistance.

Steel ball weight: Whether a lens was broken was observed by performing a drop ball test using steel balls having weights of 16 g, 32 g, 65 g, 100 g, 200 g, and 300 g, thereby calculating potential energy when the specimen was broken.

Calculation Example-1) When FDA standards (16 g, 127 cm) are applied, potential energy (Ep) is calculated as follows.

Ep=mgh=0.016*9.8*1.27=0.2 (J)

Calculation Example-2) When industrial safety standards (67 g, 127 cm) are applied, potential energy (Ep) is calculated as follows.

Ep=mgh=0.067*9.8*1.27=0.83 (J)

(2) Heat resistance: Glass transition temperature (Tg) of a specimen was measured using a thermal analyzer (DSC N-650, SCINCO Co., Ltd.), thereby evaluating heat resistance.

(4) Specific gravity: Specific gravity was measured by Archimedes' method.

(5) Whether to block near-infrared light or not and Transmittance: An absorption spectrum of a specimen, which was a flat lens having a thickness of 1.2 mm, was measured using a UV/Vis-NIR spectrophotometer (UV-3600, SHIMADZU Co., Ltd.), thereby directly measuring transmittance (T %) in a visible light range (400 nm to 800 nm) from the absorption spectrum.

(Typical Method of Producing Optical Lens)

A monomer constituting polyisocyanate was mixed with a near-infrared absorbent in a predetermined ratio, followed by stirring subsequent to addition of a monomer constituting polythiol to the mixture in a predetermined amount. Then, an internal release agent, a UV absorber, an organic dye, and a curing catalyst were added to the resultant mixture in specific amounts, respectively, thereby obtaining a polyurethane optical resin composition. Then, the obtained resin composition was subjected to degassing for a predetermined period of time and then injected into a glass mold assembled with an adhesive tape.

Thereafter, the glass mold with the resin composition introduced therein was loaded into a forced convection oven. The mixture was polymerized by performing the following processes in the oven, followed by cooling the mixture: Heating from room temperature to 35° C. for 4 hours, heating from 35° C. to 50° C. for 5 hours, heating from 50° C. to 75° C. for 4.5 hours, heating from 75° C. to 90° C. for 5 hours, maintaining at 90° C. for 3 hours, heating from 90° C. to 130° C. for 2 hours, maintaining at 130° C. for 1.5 hours, and cooling from 130° C. to 70° C. for 1 hour. After completion of polymerization, the mixture was separated from the mold, thereby obtaining a urethane optical lens. The obtained lens was annealed at 120° C. for 1 hour and 40 minutes. After annealing, a cured raw lens was released from a glass mold, thereby obtaining an optical lens having a central thickness of 1.2 mm.

The obtained optical lens was processed to a diameter of 80 mm, followed by ultrasonically cleaning the optical lens with an aqueous alkaline cleaning solution, and then annealed at 120° C. for 2 hours. Next, the raw lens is coated by dipping into a silicone hard coating liquid and then thermally dried. Next, silicon oxide, zirconium oxide, silicon oxide, ITO, zirconium oxide, silicon oxide and zirconium oxide were vacuum-deposited onto both surfaces of the lens in the stated order, thereby obtaining a hard-coated and multi-coated optical lens.

### EXAMPLE

Next, the near-infrared blocking optical lens according to the present invention will be described in more detail with reference to some examples.

### Example 1

### High Refractive (nD=1.60), Impact Resistant PU Lens: NIR 300 ppm

21.18 g of HDI Biuret, 14.12 g of HDI and 21.18 g of IPDI were mixed and stirred, followed by adding 0.03 g (300 ppm) of a near-infrared absorbent (0.012 g of PANAX FND-83, 0.006 g of PANAX FND-88, 0.012 g of PANAX FND-96) to the mixture, and then stirred under a pressure of 10 torr or less for 40 minutes, thereby obtaining 56.48 g of a mixture of a polyisocyanate corresponding to a liquid (I) and the near-infrared absorbent. Next, 7.27 g of PEMP and 36.26 g of GST, as polythiol compounds, were mixed and stirred under a pressure of 10 torr or less for 40 minutes, thereby obtaining 43.53 g of a polythiol corresponding to a liquid (II). Next, the obtained liquid (II) was mixed with 56.48 g of the mixture of the liquid (I) and mixed with 0.12 g (1,200 ppm) of a release agent (phosphoric acid ester commercially available as ZELEC UN from DuPont Co., Ltd.) and 1.5 g (15,000 ppm) of a UV absorbent (2-(2′-hydroxy-5′-t-octylphenyl)benzothiazole commercially available as UV-329), followed by stirring under a pressure of 10 torr or less for about 40 minutes.

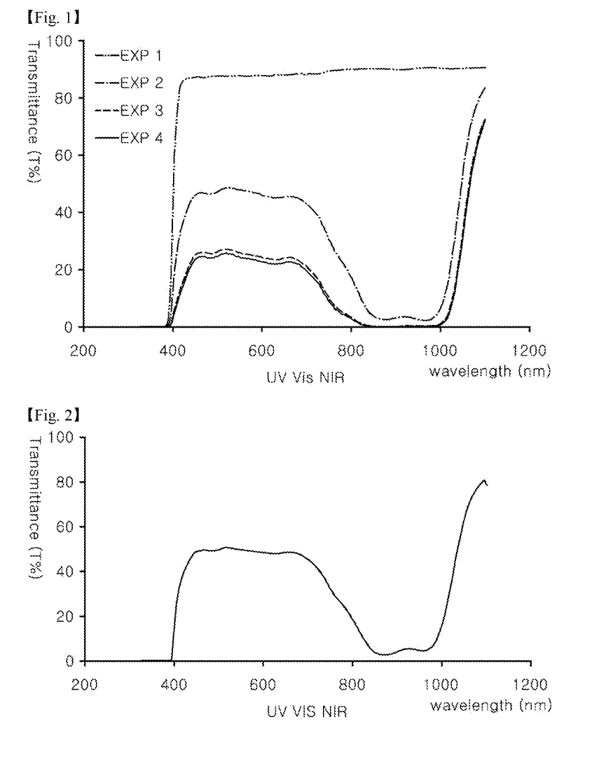

Finally, the mixture was mixed with 0.063 g (630 ppm) of a catalyst (dibutyltin chloride) and stirred under a pressure of 10 torr or less for about 20 minutes, thereby finally obtaining an optical resin composition. The obtained composition was injected into an adhesive-taped glass mold, followed by curing in an oven pre-programmed (to be heated from room temperature to 35° C. for 4 hours, heated from 35° C. to 50° C. for 5 hours, heated from 50° C. to 75° C. for 4.5 hours, heated from 75° C. to 90° C. for 5 hours, maintained at 90° C. for 3 hours, heated from 90° C. to 130° C. for 2 hours, maintained at 130° C. for 1.5 hours, and cooled from 130° C. to 70° C. for 1 hour), and then released from the glass mold, thereby obtaining a lens. UV-Vis-NIR analysis results of the obtained near-infrared blocking lens are shown in FIG. 2.

### Example 2

### High Refractive (nD=1.60), Impact Resistant PU Lens: NIR 700 ppm

A near-infrared blocking lens was obtained in the same manner as in Example 1 except that 0.07 g (700 ppm) of the near-infrared absorbent (0.028 g of PANAX FND-83, 0.014 g of PANAX FND-88, 0.028 g of PANAX FND-96) was used. UV-Vis-NIR analysis results of the obtained near-infrared blocking lens are shown in FIG. 3.

### Example 3

### High Refractive (nD=1.60), Impact Resistant PU Lens: NIR 1000 ppm

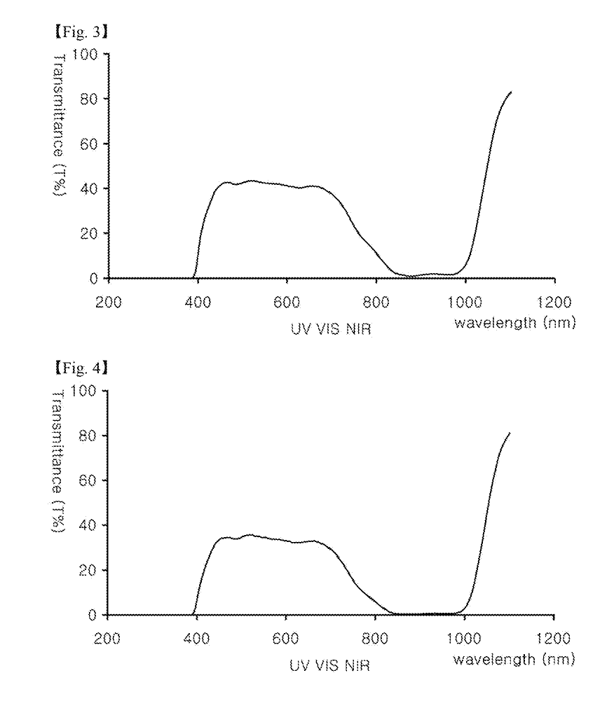

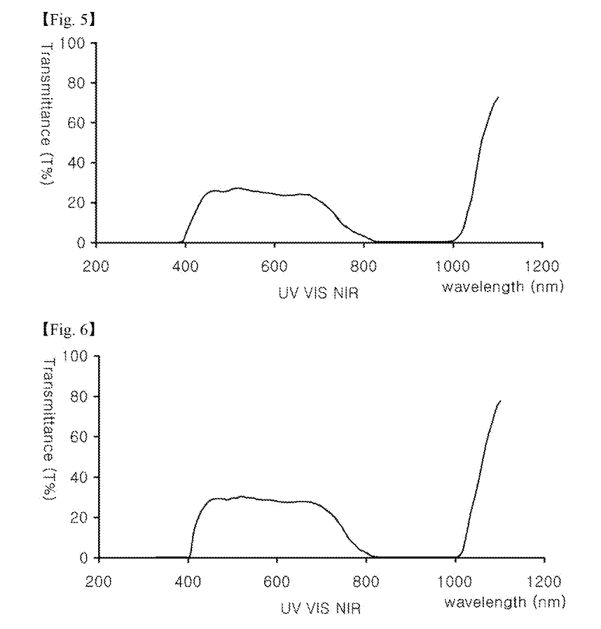

A near-infrared blocking lens was obtained in the same manner as in Example 1 except that 0.1 g (1,000 ppm) of the near-infrared absorbent (0.04 g of PANAX FND-83, 0.02 g of PANAX FND-88, 0.04 g of PANAX FND-96) was used. UV-Vis-NIR analysis results of the obtained near-infrared blocking lens are shown in FIG. 4.

Table 1 shows summarized results of lens properties, such as impact resistance energy (E), Tg, index of refraction, Abbe number, and transmittance, which were measured on the lenses according to each of the monomer compositions of Examples 1 to 3 by the measurement methods set forth above.

TABLE 1

| | | Example 1 | Example 2 | Example 3 |
|---|---|---|---|---|
| Monomer | HDI Biuret(g) | 21.18 g | 21.18 g | 21.18 g |
| composition | HDI (g) | 14.12 g | 14.12 g | 14.12 g |
| (g) | IPDI (g) | 21.18 g | 21.18 g | 21.18 g |
| | PEMP (g) | 7.27 g | 7.27 g | 7.27 g |
| | GST (g) | 36.26 g | 36.26 g | 36.26 g |
| | Near-infrared | 0.03 g | 0.07 g | 0.1 g |
| | absorbent | (300 ppm) | (700 ppm) | (1,000 ppm) |
| Lens | Impact | 5.5 J | 5.5 J | 5.5 J |
| properties | resistance E(J) | | | |
| | Tg (° C.) | 89.79° C. | 90.8° C. | 90.2° C. |
| | Index of | 1.5928 | 1.5926 | 1.5932 |
| | refraction (nD) | | | |
| | Abbe number | 42.6 | 40 | 41 |
| | (νd)) | | | |
| | Appearance | Black | Dark black | Dark black |
| | | Transparent | Transparent | Transparent |
| | Transmittance | 50.4% | 43.7% | 35.7% |
| | (T %) (520 nm) | (520 nm) | (520 nm) | (520 nm) |

As can be seen from Table 1 and FIGS. 2 to 4, when the lens included all of the high-impact resistance and high refractive (nD=1.6) poly(thio)urethane composition, the UV absorbent and the near-infrared absorbent, the lens blocked UV light having a wavelength of 400 nm or less and efficiently blocked near-infrared light having a wavelength of 800 nm to 1000 nm. In addition, it was understood that the lens could be sufficiently used as sunglasses since the lens had a relatively high transmittance of 35.7% to 50.5% (at 520 nm) in a visible light range (400 nm to 800 nm), and that the lens would be advantageously used as outdoor and sports sunglasses particularly due to high impact resistance thereof.

### Example 4

### Medium Refractive (nD=1.56), Impact Resistant PU Lens: NIR 700 ppm

In this example, the same components and process as in Example 1 were applied except for the following components and processes. The release agent, the UV absorbent, the organic dye and the catalyst, which were used in Example 1, were unchanged.

18.45 g of HDI biuret, 12.3 g of HDI and 18.45 g of IPDI were mixed and stirred, followed by introducing 0.07 g (700 ppm) of the near-infrared absorbent (0.028 g of PANAX FND-83, 0.014 g of PANAX FND-88, 0.028 g of PANAX FND-96) to the mixture, and then stirred under a pressure of 10 torr or less for 40 minutes, thereby obtaining 49.21 g of a mixture of a liquid (I). 49.21 g of the obtained liquid (I) was mixed with 50.78 g of PEMP, 0.12 g (1200 ppm) of the release agent and 1.5 g (15000 ppm) of the UV absorbent and stirred under a pressure of 10 torr or less for about 40 minutes. Finally, the mixture was mixed with 0.063 g (630 ppm) of the catalyst and stirred under a pressure of 10 torr or less for about 20 minutes. A process subsequent to stirring was the same as in Example 1. UV-Vis-NIR analysis results of an obtained near-infrared blocking lens are shown in FIG. 5.

### Example 5

### High Refractive (nD=1.60), NBDI-GST-PEMP PU Lens: NIR 700 ppm)

In this example, the same components and process as in Example 1 were applied except for the following components and processes. The release agent, the UV absorbent, the organic dye and the catalyst, which were used in Example 1, were unchanged.

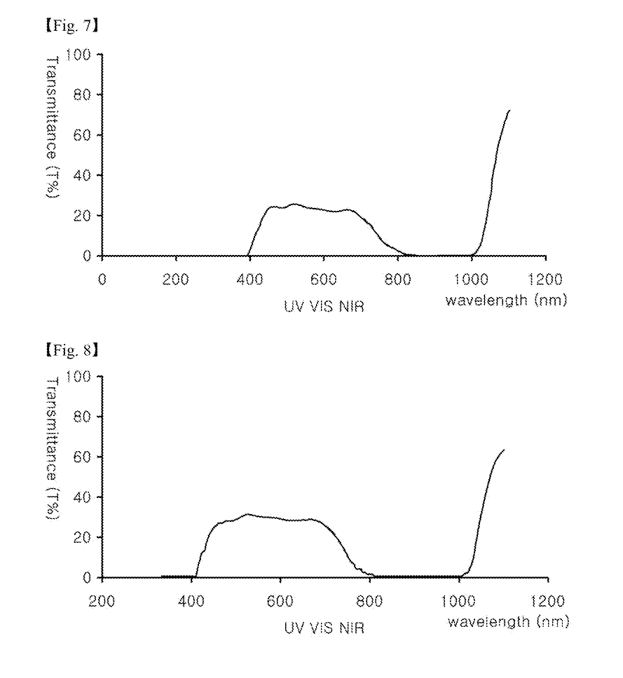

50.52 g of NBDI was mixed with 0.07 g (700 ppm) of a near-infrared absorbent (0.028 g of PANAX FND-83, 0.014 g of PANAX FND-88, 0.028 g of PANAX FND-96), followed by further stirring under a pressure of 10 torr or less for about 40 minutes, thereby obtaining a liquid (I). In addition, 23.94 g of PEMP was mixed with 25.53 g of GST, followed by stirring under a pressure of 10 torr or less for 40 minutes, thereby obtaining a liquid (II). Then, the liquid (II) was mixed with 50.52 g of the liquid (I), 0.12 g (1,200 ppm) of the release agent, 1.5 g (15,000 ppm) of the UV absorbent, and 0.5 g (5,000 ppm) of the dye, followed by stirring under a pressure of 10 torr or less for about 40 minutes. Finally, the mixture was mixed with 0.063 g (630 ppm) of the catalyst and stirred under a pressure of 10 torr or less for about 20 minutes. A process subsequent to stirring was the same as in Example 1. UV-Vis-NIR analysis results of an obtained near-infrared blocking lens are shown in FIG. 6.

### Example 6

### Ultrahigh Refractive (nD=1.67), XDI-GST PU Lens: NIR 700 ppm)

In this example, the same components and process as in Example 1 were applied except for the following components and processes. The release agent, the UV absorbent, the organic dye and the catalyst, which were used in Example 1, were unchanged.

52 g of XDI was mixed with 0.07 g (700 ppm) of the near-infrared absorbent (0.028 g of PANAX FND-83, 0.014 g of PANAX FND-88, 0.028 g of PANAX FND-96), followed by further stirring under a pressure of 10 torr or less for about 40 minutes, thereby obtaining a liquid (I). Then, the obtained liquid (I) was mixed with 48 g of GST, 0.12 g (1,200 ppm) of the release agent, 1.5 g (15,000 ppm) of the UV absorbent, and 0.5 g (5,000 ppm) of the dye, followed by stirring under a pressure of 10 torr or less for about 40 minutes. Finally, the mixture was mixed with 0.02 g (200 ppm) of the catalyst and stirred under a pressure of 10 torr or less for about 20 minutes. A process subsequent to stirring was the same as in Example 1. UV-Vis-NIR analysis results of an obtained near-infrared blocking lens are shown in FIG. 7.

### Example 7

### Ultrahigh Refractive (nD=1.67), XDI-DMDDU PU lens: NIR 700 ppm)

A near-infrared blocking lens was obtained in the same manner as in Example 6 except that DMDDU was used instead of GST as the polythiol compound. UV-Vis-NIR analysis results of the obtained near-infrared blocking lens are shown in FIG. 8.

Table 2 shows summarized results of lens properties, such as impact resistance energy (E), Tg, index of refraction, Abbe number, and transmittance, which were measured on the lenses according to each of the monomer compositions of Examples 4 to 7 by the measurement methods set forth above.

TABLE 2

| | | Example 4 | Example 5 | Example 6 | Example 7 |
|---|---|---|---|---|---|
| Monomer | HDI Biuret (g) | 18.45 g | | | |
| composition | HDI (g) | 12.3 g | | | |
| (g) | IPDI (g) | 18.45 g | | | |
| | NBDI (g) | | 50.52 g | | |
| | XDI (g) | | | 52 g | 50.65 g |
| | PEMP (g) | 50.78 g | 23.94 g | | |
| | GST (g) | | 25.53 g | 48 g | |
| | DMDDU (g) | | | | 49.35 g |
| | Near-infrared | 0.07 g | 0.07 g | 0.07 g | 0.07 g |
| | absorbent | (700 ppm) | (700 ppm) | (700 ppm) | (700 ppm) |
| Lens | Impact | 3.35 J | 1.62 J | 0.3 J | 0.3 J |
| properties | resistance E(J) | | | | |
| | Tg (° C.) | 84.6° C. | 118.18° C. | 86.4° C. | 106.5° C. |
| | Index of | 1.5928 | 1.6029 | 1.6624 | 1.6631 |
| | refraction (nD) | | | | |
| | Abbe number | 48 | 41.2 | 30.8 | 30.3 |
| | (νd)) | | | | |
| | Appearance | Black | Black | Black | Black |
| | | Transparent | Transparent | Transparent | Transparent |
| | Transmittance | 27.2% | 30.1% | 25.6% | 30.9% |
| | (T %) (520 nm) | (520 nm) | (525 nm) | (520 nm) | (525 nm) |

Table 2 and FIGS. 5 to 8 show results of lens properties obtained when the index of refraction of a urethane resin was changed such that the urethane resin became each of medium, high and ultrahigh refractivity resins while the concentration of the near-infrared absorbent was fixed to 700 ppm. In addition, when the UV absorbent and the near-infrared absorbent according to the present invention were included in commercially available medium refractivity to ultrahigh refractivity monomer compositions, it was thought that the monomer compositions efficiently blocked harmful UV light and near-infrared light, had a visible light transmittance of 25.6% to 30.9% and thus could be sufficiently used for sunglasses. Thus, it could be seen that the near-infrared absorbent according to the present invention could be applied to various urethane optical lenses.

### Example 8

A near-infrared blocking lens was obtained in the same manner as in Example 1 except that MET was used instead of GST as the polythiol compound and 0.07 g (700 ppm) of the near-infrared absorbent (0.028 g of PANAX FND-83, 0.014 g of PANAX FND-88, 0.028 g of PANAX FND-96) was used. UV-Vis-NIR analysis results of the obtained near-infrared blocking lens are shown in FIG. 9.

### Example 9

In this example, the same components and process as in Example 1 were applied except for the following components and processes. The release agent, the UV absorbent, the organic dye and the catalyst, which were used in Example 1, were unchanged.

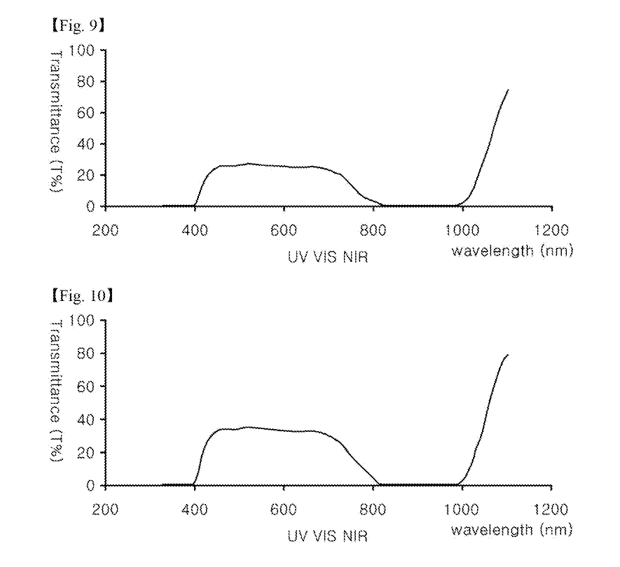

18.16 g of HDI biuret was mixed with 12.1 g of HDI 12.1g, and 18.16 g of IPDI, followed by stirring, and then 0.07 g (700 ppm) of the near-infrared absorbent (0.028 g of PANAX FND-83, 0.014 g of PANAX FND-88, 0.028 g of PANAX FND-96) was added to the mixture, followed by stirring under a pressure of 10 torr or less for about 40 minutes, thereby obtaining 48.42 g of a mixture of a liquid (I). Then, 48.42 g of the obtained liquid (I) was mixed with 8.62 g of PEMP, 42.96 g of SET, 0.12 g (1,200 ppm) of the release agent, and 1.5 g (15,000 ppm) of the UV absorbent, followed by stirring under a pressure of 10 torr or less for about 40 minutes. Finally, the mixture was mixed with 0.063 g (630 ppm) of the catalyst and stirred under a pressure of 10 torr or less for about 20 minutes. A process subsequent to stirring was the same as in Example 1. UV-Vis-NIR analysis results of an obtained near-infrared blocking lens are shown in FIG. 10.

Table 3 shows summarized results of lens properties, such as impact resistance energy (E), Tg, index of refraction, Abbe number, and transmittance, which were measured on the lenses according to each of the monomer compositions of Examples 8 and 9 by the measurement methods set forth above.

TABLE 3

| | | Example 8 | Example 9 |
|---|---|---|---|
| Monomer | HDI Biuret | 21.18 g | 18.18 g |
| composition | (g) | | |
| (g) | HDI (g) | 14.12 g | 12.1 g |
| | IPDI (g) | 21.18 g | 18.18 g |
| | PEMP (g) | 7.27 g | 8.61 g |
| | MET (g) | 36.26 g | |
| | SET (g) | | 42.96 g |
| | Near-infrared | 0.07 g (700 ppm) | 0.07 g (700 ppm) |
| | absorbent | | |
| Lens | Impact | 3.7 J | 5.5 J |
| properties | resistance | | |
| | E(J) | | |
| | Tg (° C.) | 85.0° C. | 78.38° C. |
| | Index of | 1.5929 | 1.5902 |
| | refraction | | |
| | (nD) | | |
| | Abbe number | 40.9 | 39.8 |
| | (νd)) | | |
| | Appearance | Black Transparent | Black Transparent |
| | Transmittance | 26.8% (520 nm) | 35.3% (520 nm) |
| | (T %) (520 nm) | | |

Table 3 and FIGS. 9 and 10 show results of lens properties obtained when each of MET and SET was used as the polythiol compound while the concentration of the near-infrared absorbent was fixed to 700 ppm. The lenses of Examples 8 and 9 had excellent near-infrared blocking efficiency. In addition, the lenses of Examples 8 and 9 had a good visible light transmittance of 26.8% to 35.5%, and in particular, had excellent impact resistance energies of 3.7 J and 5.5 J, respectively. Therefore, even if the kind of polythiol included in the lenses is changed, it is expected that the lenses can be used as sunglasses due to high electromagnetic wave blocking efficiency thereof.

### Example 10

### Production of High Refractivity Optical Lens through Coating

In this example, an optical lens was prepared in the same manner as in Example 1 except that the near-infrared absorbent was not used. Then, the prepared lens was impregnated with a near-infrared absorbent coating solution, followed by curing, thereby obtaining a near-infrared blocking lens.

Specifically, 21.18 g of HDI biuret, 14.12 g of HDI and 21.18 g of IPDI were mixed, followed by stirring, thereby obtaining 56.48 g of a mixture corresponding to a liquid (I). Then, 7.27 g of PEMP was mixed with 36.26 g of GST, followed by stirring under a pressure of 10 torr or less for 40 minutes, thereby obtaining 43.53 g of a polythiol corresponding to a liquid (II). Next, the obtained liquid (II) was mixed with 56.48 g of the liquid (I), 0.12 g (1,200 pm) of a release agent (phosphoric acid ester commercially available as ZELEC UN from DuPont Co., Ltd.), and 1.5 g (15,000 ppm) of a UV absorbent (2-(2′-hydroxy-5′-t-octylphenyl)benzothiazole commercially available as UV-329), followed by stirring under a pressure of 10 torr or less for about 40 minutes.

Finally, the mixture was mixed with 0.063 g (630 ppm) of a catalyst (dibutyltin chloride) and stirred under a pressure of 10 torr or less for about 20 minutes, thereby finally obtaining an optical resin composition. The obtained composition was injected into an adhesive-taped glass mold, followed by curing in an oven pre-programmed (to be heated from room temperature to 35° C. for 4 hours, heated from 35° C. to 50° C. for 5 hours, heated from 50° C. to 75° C. for 4.5 hours, heated from 75° C. to 90° C. for 5 hours, maintained at 90° C. for 3 hours, heated from 90° C. to 130° C. for 2 hours, maintained at 130° C. for 1.5 hours, and cooled from 130° C. to 70° C. for 1 hour), and then released from the glass mold, thereby obtaining a lens.

32 g of SANPRENE® LQ 3510 (Sanyo Chemical Industries, Inc.) containing 0.2% of Fluorad® FC-430 (3M Company) was mixed with 45 g of toluene and 23 g of isopropyl alcohol and then 0.3 g of a near-infrared absorbent (0.12 g of PANAX FND-83, 0.06 g of PANAX FND-88, 0.12 g of PANAX FND-96) was added to the mixture and dissolved, thereby obtaining a near-infrared absorbent coating solution.

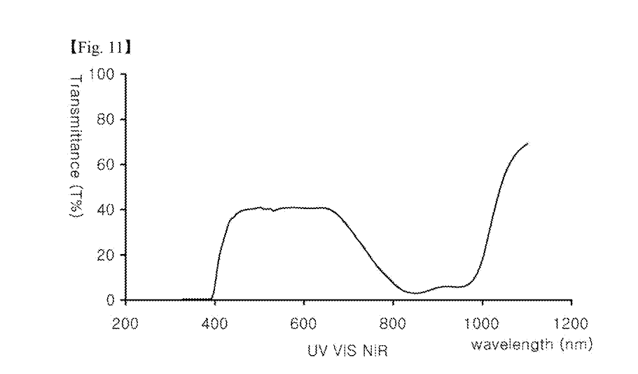

Then, the obtained lens was impregnated with the near-infrared absorbent coating solution, followed by dip coating at a rate of 10 cm/min, thereby obtaining a near-infrared blocking lens. UV-Vis-NIR analysis results of the obtained near-infrared blocking lens are shown in FIG. 11.

(Imparting Additional Functions to Optical Lens)

The present invention is not limited to the embodiments set forth above. For example, a polarizing function (function of transmitting light only at a specific angle and minimizing reflection light from a surface of a non-metallic object) and a dimming function (function of enabling automatic control of illuminance by considering surrounding environments and space utilization) may be imparted to the polyurethane resin composition according to the present invention. Further, an eyesight correction function may be imparted to an optical lens.

Although described as being limited to an optical lens, the polyurethane resin composition according to the present invention may be applied to a windowpane for sliding windows, double or single hung windows, and casement windows, which are used in buildings and the like and require infrared absorption. In order to expand application range of the polyurethane resin composition to the windowpane, the polyurethane resin composition according to the present invention, which includes a phthalocyanine pigment, may be molded using various-shaped glass molds such that the polyurethane resin composition is fitted to a desired window frame, followed by curing the polyurethane resin composition. Next, the polyurethane resin composition may be released from the glass molds and used as the windowpane.

1. A preliminary composition for an optical composition for blocking electromagnetic waves, comprising:
(1) at least one polyisocyanate compound; and
(2) an electromagnetic wave absorbent having high near-infrared absorbency corresponding to a transmittance of less than 5% at a wavelength of 800 nm to 1,000 nm.

2. The preliminary composition according to claim 1, wherein the electromagnetic wave absorbent is present in an amount of 0.01 wt % to 0.5 wt % based on the total weight of the preliminary composition.

3. The preliminary composition according to claim 2, wherein the electromagnetic wave absorbent is a near-infrared absorbent composed of a mixture of a plurality of phthalocyanine pigments having different structures.

4. The preliminary composition according to claim 3, wherein the plurality of phthalocyanine pigments have a transmittance of less than 10% as minimum values of spectral transmittance curves in (i) a wavelength range of 800 nm to 850 nm, (ii) a wavelength range of 875 nm to 925 nm, and (iii) a wavelength range of 950 nm to 1,000 nm, respectively.

5. The preliminary composition according to claim 3, wherein the polyisocyanate compound comprises at least one selected from the group consisting of xylylene diisocyanate (XDI), 2,5(6)-bis(isocyanatomethyl)bicyclo[2,2,1]heptane (NBDI), 1,6-hexamethylene diisocyanate (HDI), isophorone diisocyanate (IPDI), dicyclohexylmethane diisocyanate (H12MDI) and a biuret of aliphatic isocyanate.

6. An optical composition for blocking electromagnetic waves, comprising: the preliminary composition according to claim 4; and at least one polyol or polythiol compound.

7. The optical composition according to claim 6, wherein the polythiol compound comprises at least one selected from the group consisting of 2,3-bis(2-mercaptoethylthio)propane-1-thiol (GST), pentaerythritol tetrakis(mercaptopropionate) (PEMP), 1,3-bis(2-mercaptoethylthio)propane-2-thiol (MET), (3,6,10,13-tetrathiapentadecane-1,8,15-trithiol) (SET), 2-(2-mercaptoethylthio) propane-1,3-dithiol (GMT), and 4,8-dimercaptomethyl-1,11-dimercapto-3,6,9-trithiaundecane (DMDDU).

8. The optical composition according to claim 6, further comprising: a UV absorbent capable of absorbing UV light with a wavelength of 400 nm or less, wherein the UV absorbent comprises at least one selected from the group consisting of 2-(2′-hydroxy-5-methylphenyl)-2H-benzotriazole; 2-(2′-hydroxy-3′,5′-di-t-butylphenyl)-5-chloro-2H-benzotriazole; 2-(2′-hydroxy-3′-t-butyl-5′-methylphenyl)-5-chloro-2H-benzotriazole; 2-(2′-hydroxy-3′,5′-di-t-amylphenyl)-2H-benzotriazole; 2-(2′-hydroxy-3′,5′-di-t-butylphenyl)-2H-benzotriazole; 2-(2′-hydroxy-5′-t-butylphenyl)-2H-benzotriazole; 2-(2′-hydroxy-5′-t-octylphenyl)-2H-benzotriazole; 2,4-dihydroxybenzophenone; 2-hydroxy-4-methoxybenzophenone; 2-hydroxy-4-octyloxybenzophenone; 4-dodecyloxy-2-hydroxybenzophenone; 4-benzyloxy-2-hydroxybenzophenone; 2,2′,4,4′-tetrahydroxybenzophenone; and 2,2′-dihydroxy-4,4′-dimethoxybenzophenone.

9. An optical lens produced from the optical composition for blocking electromagnetic waves according to claim 6.

10. The optical lens according to claim 9, the optical lens further having a polarizing function, a dimming function, or a combination thereof.

11. A windowpane used in sliding windows, double or single hung windows, or casement windows, wherein the windowpane is produced from the optical composition for blocking electromagnetic waves according to claim 6.

12. A method of producing an optical lens for blocking electromagnetic waves, comprising:
(1) obtaining a liquid (I) of an optical composition comprising at least one polyisocyanate compound;
(2) obtaining a liquid (II) of the optical composition comprising at least one polyol or polythiol compound;
(3) obtaining a uniform electromagnetic wave absorbent solution by mixing the polyisocyanate compound used in the liquid (I) with a near-infrared absorbent, a UV absorbent, or both thereof, wherein the near-infrared absorbent has high near-infrared absorption capabilities corresponding to a transmittance of less than 5% at a wavelength of 800 nm to 1000 nm, and the UV absorbent has absorption capabilities of UV light with a wavelength of 400 nm or less; and
(4) mold-polymerizing the optical composition prepared by mixing the liquid (I), the liquid (II), and the electromagnetic wave absorbent solution.

13. The method according to claim 12, wherein the near-infrared absorbent is a mixture of a plurality of phthalocyanine pigments having different structures.

14. The method according to claim 13, wherein the plurality of phthalocyanine pigments have a transmittance of less than 10% as minimum values of spectral transmittance curves in (i) a wavelength range of 800 nm to 850 nm, (ii) a wavelength range of 875 nm to 925 nm, and (iii) a wavelength range of 950 nm to 1,000 nm, respectively.

15. A method of producing an optical lens for blocking electromagnetic waves, comprising:
(1) obtaining a liquid (I) of an optical composition comprising at least one polyisocyanate compound and a liquid (II) of the optical composition comprising at least one polyol or polythiol compound;
(2) preparing an optical lens by mold-polymerizing a mixture of the liquid (I) and the liquid (II);
(3) obtaining a near-infrared absorbent coating solution by dissolving a mixture of a plurality of phthalocyanine pigments in an emulsion and a solution, wherein the phthalocyanine pigments has different structures and high near-infrared absorbency corresponding to a transmittance of less than 5% at a wavelength of 800 nm to 1000 nm;
(4) forming an electromagnetic wave blocking layer by coating at least one surface of the optical lens obtained in step (2) with the near-infrared absorbent coating solution obtained in step (3); and
(5) drying or curing the electromagnetic wave blocking layer formed on at least one surface of the optical lens.

16. The method according to claim 15, wherein the plurality of phthalocyanine pigments have a transmittance of less than 10% as minimum values of spectral transmittance curves in (i) a wavelength range of 800 nm to 850 nm, (ii) a wavelength range of 875 nm to 925 nm, and (iii) a wavelength range of 950 nm to 1,000 nm, respectively.

17. The method according to claim 15, wherein, in step (4), coating is performed by at least one of spin coating, dip coating, spray coating, and roll coating.

18. The method according to claim 17, further comprising: subjecting the optical lens having the electromagnetic wave blocking layer formed thereon to at least one of hard coating, multi-coating, UV coating, photochromic coating, water film coating, and super water-repellent coating, after drying or curing in step (4).
